(19) United States
(12) Patent Application Publication
(10) Pub. No.: US 2013/0171299 A1
(43) Pub. Date: Jul. 4, 2013

(54) CONSUMABLES AND METHODS OF PRODUCTION THEREOF

(71) Applicants: Peter Clarke, Berkshire (GB); Sarah Marshall, West Berkshire (GB); Clive Richard Thomas Norton, Chatham, NJ (US)

(72) Inventors: Peter Clarke, Berkshire (GB); Sarah Marshall, West Berkshire (GB); Clive Richard Thomas Norton, Chatham, NJ (US)

(21) Appl. No.: 13/583,373

(22) PCT Filed: Mar. 23, 2011
(86) PCT No.: PCT/GB2011/050593

§ 371 Date: Nov. 15, 2012

Related U.S. Application Data
(60) Provisional application No. 61/316,449, filed on Mar. 23, 2010.

(30) Foreign Application Priority Data
Mar. 23, 2010 (GB) 1004898.1

(51) Int. Cl. A23G 3/54

(52) U.S. Cl. CPC A23G 3/545
USPC 426/93; 426/660; 426/631; 426/514; 426/517; 426/282; 426/302; 426/306; 426/103

(57) ABSTRACT

The present invention relates to a confectionery composition comprising an at least partially convoluted or rolled sheet of a confectionery material having at least one capillary disposed therein, wherein the composition has a longitudinal axis which extends along the convolutions or axis of rolling and the at least one capillary runs parallel, perpendicular or at an inclined angle relative to the longitudinal axis of the product. The present invention also relates to a method of production of the same.

### TECHNICAL FIELD OF THE INVENTION

The present invention relates to a confectionery composition comprising an at least partially convoluted or rolled sheet of a confectionery material having at least one capillary disposed therein. In particular, the invention relates to a chocolate confectionery composition.

### BACKGROUND TO THE INVENTION

Layered products comprising layers of sheets, especially layered confectionery products, are known and are described for example in, WO 03/005832. Layered sheet products are generally formed by chocolate or other confectionery paste being applied to a roll from which a confectionery film is scraped and collected, in an appropriate former, to form a product. The speed of the roll can be controlled to remove the film as a continuous sheet, and the angle of the scraper blade can be controlled to collect the film as a wrinkled, partially compressed bar of confectionery product of a length equal to the width of the roll. The width of the bar, or the quantity scraped from the roll, can be mechanically controlled by intermittent stopping and starting of the roll, A take-off device then removes the formed bar from the scraper blade while the roll is stationary. The length of the separate bars may be further controlled by mechanical means such as small sharp protrusions at defined intervals along the scraper blade breaking the film into discrete lengths. Processes like those described in WO 03/005832, however, give rise to sheets comprising only one ingredient, usually chocolate.

It would be advantageous to provide sheets, and products made therefrom, wherein the sheets are not simply plain chocolate sheets, since this would increase consumer appeal.

It would also be advantageous to provide confectionery sheets having a reduced fat/sugar content and/or sheets which melt of dissolve at a greater rate in the mouth.

The present invention therefore aims to produce edible sheets that exhibit improved taste and/or mouth-feel and/or improved consumer pleasure. It would also be desirable to produce an edible sheet that is of increased visual interest.

### SUMMARY OF THE INVENTION

According to an aspect of the present invention there is provided a confectionery composition comprising an at least partially convoluted or rolled sheet of a confectionery material having at least one capillary disposed therein, wherein the composition has a longitudinal axis which extends along the convolutions or axis of rolling and the at least one capillary runs parallel, perpendicular or at an inclined angle relative to the longitudinal axis of the product.

As used herein, the term ‘convoluted’ is intended to mean a sheet which has a non-planar shape and having one or more folds. It is preferred that the sheet has two or more folds. In particular, the sheet may be formed with a number of ridges and folds, the size of the ridges and folds being large in relation to the thickness of the sheet. The folds may be regular, so that (for example) the sheet is formed into hollow cylindrical tubes. Alternatively, the folds may be random. In such an embodiment, the convolutions are random. In this context, the term ‘random’ is intended to mean that no one fold follows an identical path to a previous fold. The convoluted chocolate sheet may be formed into a layer having a thickness which is substantially greater than the thickness of the sheet. For example, the layer may be at least 10 times, at least 20 times, or at least 50 times thicker than the sheet. It will be understood that this results in the bulk volume of the layer being significantly greater than the volume of constituent chocolate, the additional volume being air pockets defined between folds of the chocolate sheet.

The term “rolled” is intended to mean that the sheet has been curled to some degree. The term includes, but not limited to coiling and curling the sheet so as to provide a cylindrically shaped product.

It should be understood that the term “capillary” generally refers to a conduit or space created by an extrusion or other forming process within the body of the product. The capillary typically contains matter, and that matter can be in the form of a gas, a liquid, a solid, or a mixture thereof.

It is preferable that the sheet of confectionery material is of minimal thickness. The sheet may be no more than 5 mm, or no more than 2.5 mm—but generally no more than 1 mm.

In some embodiments the sheet comprises chocolate. Suitable chocolate includes dark, milk, white and compound chocolate. In some embodiments the confectionery may comprise chewing guru, bubble gum or gum base. In other embodiments the confectionery is candy. Suitable candy includes hard candy, chewy candy, gummy candy, jelly candy, toffee, nougat and the like.

If chocolate is employed, it may comprise at least one fat. The fat may be cocoa butter, butterfat, a cocoa butter equivalent (CBE), a cocoa butter substitute (CBS), a vegetable fat that is liquid at standard ambient temperature and pressure (SATP, 25° C. and 100 kPa) or any combination of the above. In a particular embodiment, the chocolate comprises cocoa butter. CBEs are defined in Directive 2000/36/EC. Suitable CBEs include illipe, Borneo tallow, tengkawang, palm oil, sal, shea, kokum gurgi and mango kernel. CBE's are usually used in combination with cocoa butter. Suitable vegetable fats include corn oil, cotton seed oil, rapeseed oil, palm oil, safflower oil, and sunflower oil.

The capillary may be filled with a fluid material. This fluid material may be in a gaseous phase and may simply be air. Alternatively, the fluid material may be a liquid or a material which is liquid during the formation of the sheet. The fluid material may comprise one or more of aqueous media, caramel, cocoa butter, chocolate, fondant, syrup, peanut butter, jam, jelly, gel, truffle, praline, chewy candy, hard candy, fruit or vegetable purees, medications, sauces such as ketchup, custard, cream, or any combination or mixture thereof.

The product of the composition will have a longitudinal axis which extends along the convolutions or axis of rolling and the at least one capillary may run parallel, perpendicular or at an inclined angle relative to the longitudinal axis of the product. The longitudinal axis can be defined as a line that runs from one end to another end through a central portion of the product. For example, in a cylindrically shaped product, the longitudinal axis will be a line running between the ends of the cylinder. The confectionery material will preferably be extruded and extruded as a liquid.

It should be understood that the term “liquid” is intended to mean that the material is capable or has a readiness to flow, including gels, pastes and plasticized chocolate. Furthermore, this term is intended to include (but not limited to) those materials which may be “molten” during extrusion and the skilled addressee will understand that the term “molten” means that the material has been reduced to a liquid form or a form which exhibits the properties of a liquid. The confectionery material may be at least partially or substantially solid, so that it can no longer be considered to flow in a liquid form.

The sheet may be processed into a number of configurations, such as being rolled into a coil or cylinder, or convoluted so that the sheet is folded upon itself multiple times.

Known techniques are used as necessary to facilitate the extrusion of the chocolate, for example techniques such as that discussed in EP0232156.

The at least one capillary may extend along the substantially entire length of the sheet, but may in some embodiments extend no less than 75%, 80%, 90%, 95% or 99% along the length of the sheet (for example, when it is desired to seal the ends of the sheet). If the capillaries extend along the entire length of sheet, suitably the ends of the at least one capillary are visible at one or more ends of the sheet.

There may be a plurality of capillaries, and one or more of the capillaries may be filled with a material which is different from that of the material used to form the sheet. Different capillaries may incorporate different materials if desired. The capillaries may be filled with a material which is solid at a room temperature and fluid at a temperature greater than room temperature. For example, a molten chocolate may be incorporated into the capillaries and allowed to set when cooled to room temperature. It will be apparent to the skilled addressee that room temperature is commonly regarded as around 20° C. Alternatively, the capillaries may be filled with a material which is deposited as a liquid and which subsequently solidifies. In such embodiments, the solidification may be dependent or independent of heat. It will be apparent that solidification of a liquid filled capillary may be achieved in a number of ways. For example solidification may take place due to one or more of the following:
Cooling—the filling may be molten when deposited which then cools to a solid at room temperature;
Heating—the filling may be liquid when deposited, and the heat of the extruded sheet sets the filling (e.g. pumping egg albumen into a hot hard candy extruded body portion will set the egg on contact);
Drying—the filling may be a solution that dries into a solid (e.g. the moisture from the solution is absorbed into the extruded body portion);
Solvent loss—the filling may be in a solvent, whereby the solvent is absorbed into the extruded sheet, leaving a solid;
Chemical reaction—the filling may be deposited as a liquid but reacts or “goes off” into a solid;
Cross-linking—the filling may form a constituents for a cross-linked material due to mixing and/or heating; and
Time—the filling may simply set with time (e.g. a solution of sugars and gelatin will eventually set over time).

Suitable filling materials for the capillaries include, but are not limited to, aqueous media, fats, chocolate, caramel, cocoa butter, fondant, syrups, peanut butter, jelly, gels, truffle, praline, chewy candy, hard candy, fruit or vegetable purees, medications, sauces such as ketchup, custard, cream, or any combination or mixture thereof.

If desired, the product may further comprise a coating portion to envelop or enrobe the sheet. The skilled addressee will appreciate that a number of coatings could be employed—for example chocolate, gum, candy and sugar etc.

In some embodiments where there is provided a plurality of capillaries, the capillaries are distributed substantially uniformly throughout the sheet, and may be spaced evenly apart from adjacent capillaries and/or parallel to adjacent capillaries. In other embodiments, capillaries may be distributed in pre-defined configurations within the sheet such as in waves or as intermittent lines.

It should be understood that the term “plurality” is intended to mean two or more. In some embodiments, a plurality is 3 or more, or 4 or more, or 5 or more, or 6 or more, or 7 or more. There is no particular upper limit on the number associated with “plurality”. In the context of the phrase “plurality of capillaries”, numbers up to 50 and higher are contemplated.

In another aspect of the present invention, there is provided a process for manufacturing a confectionery product comprising an at least partially convoluted or rolled sheet of a confectionery material having at least one capillary disposed therein, wherein the composition has a longitudinal axis which extends along the convolutions or axis of rolling and the at least one capillary runs parallel, perpendicular or at an inclined angle relative to the longitudinal axis of the product, wherein the process comprises the steps of:
(i) extruding an confectionery material to create a sheet comprising at least one capillary;
(ii) rolling or folding the sheet upon itself; and
(iii) optionally filling the capillary during or after extrusion.

The sheet may be formed with a plurality of capillaries.

Preferably, the process is used to make a confectionery product as herein above described.

The process may further comprise cutting and/or shaping the confectionery product so as to enable the product to be incorporated into a finished confection. Alternatively, the process may further comprise covering the confectionery product in a coating (such as chocolate).

The processes may further comprise the step of quench cooling the extruded sheet after extrusion. The quench cooling may utilise a fluid, such as air, an oil or liquid nitrogen—but other methods of quench cooling will also be apparent to the skilled addressee.

As previously mentioned, confectionery products comprising the sheets can be made by either rolling or folding the sheets upon themselves to foam a coil or cylinder. If the sheets are rolled, the sheet can form a regular spiral in cross-section, or can form a more random spiral shape. If the sheets are folded, the sheet can form an entirely random cross-section (as is seen in products such as the Cadbury® Flake®) or can form a more regular cross-section (for example regular parallel sheet surfaces which are joined at alternating ends). These products can be cut to a desired length, or can be joined together to form compound products. These products can also be coated, for example with chocolate or other confectionery product, for example in a manner similar to the Cadbury® Twirl® production process.

In accordance with yet a further aspect of the invention, there is provided an apparatus adapted for producing a confectionery product as herein above described.

### DETAILED DESCRIPTION OF THE INVENTION AND EXAMPLES

Specific examples of the present invention will now be described, by way of illustration only, with reference to the accompanying drawings, in which:

FIG. 1 is a schematic diagram illustrating the overall apparatus used in accordance with the present invention;

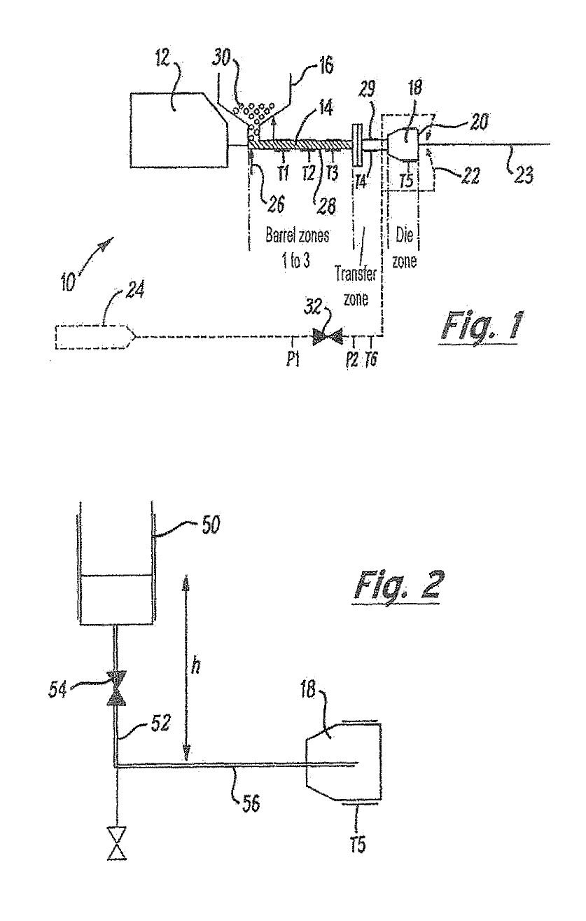

FIG. 2 is a schematic diagram illustrating the apparatus which can be used in conjunction with the apparatus shown in FIG. 1, so as to provide sheets comprising capillaries;

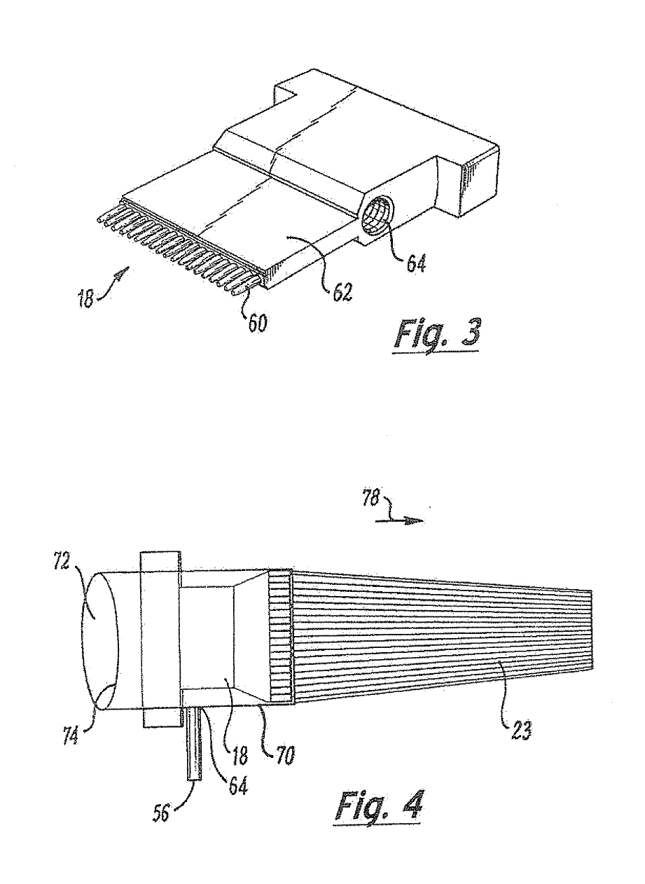

FIG. 3 is a diagram of the extrusion die used to form channels in the extruded material of the Example of FIG. 1;

FIG. 4 is a plan view of the extrusion die which incorporates the extrusion die shown in FIG. 3 in the apparatus as illustrated in FIGS. 1 and 2;

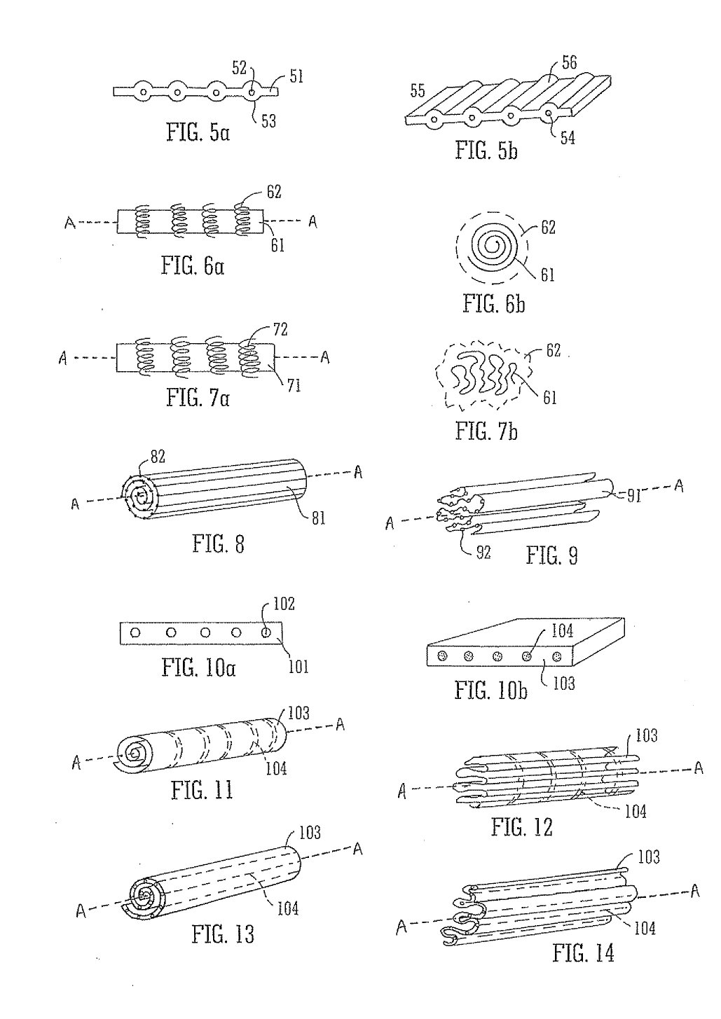

FIG. 5a is a side view of an extrusion die head used to foam a sheet according to the present invention, and FIG. 5b depicts the sheet formed by the die head;

FIG. 6a shows a side view of a confectionery product formed from the sheet of FIG. 5b, whereas 6b shows a cross-sectional view of 6a;

FIG. 7a shows a side view of a further confectionery product formed from the sheet of FIG. 5b, whereas 7b shows a cross-sectional view of 7a;

FIG. 8 shows perspective view of a confectionery product formed from the sheet of FIG. 5b where the sheet is in a coil configuration;

FIG. 9 shows a perspective view of a confectionery product formed from the sheet of FIG. 5b, where the sheet is in a convoluted configuration;

FIG. 10a is a side view of another extrusion die used to form a sheet according to the present invention, and FIG. 10b depicts the sheet formed;

FIG. 11 shows a perspective view of a confectionery product formed from the sheet of FIG. 10b, where the sheet is in a coil configuration with the capillaries running perpendicular to the longitudinal axis of the coiled sheet;

FIG. 12 shows a perspective view of a confectionery product formed from the sheet of FIG. 10b, where the sheet is in a convoluted configuration with the capillaries running perpendicular to the longitudinal axis of the convoluted sheet;

FIG. 13 shows a perspective view of a confectionery product formed from the sheet of FIG. 10b, where the sheet is in a coiled configuration with the capillaries running parallel to the longitudinal axis of the coiled sheet;

FIG. 14 shows a perspective view of a confectionery produce formed from the sheet of FIG. 10b), where the sheet is in a convoluted configuration with the capillaries running parallel to the axis of the convolutions;

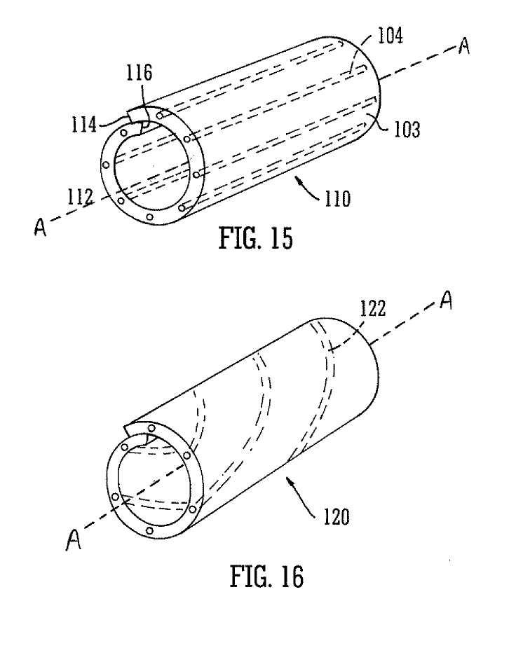

FIG. 15 shows a perspective view of a confectionery product formed from the sheet of FIG. 10b, where the sheet is in a cylindrical configuration, with the capillaries running parallel to the axis of the cylinder; and

FIG. 16 shows a perspective view of a confectionery product similar to that shown in FIG. 15, however, the capillaries run diagonally to the axis of the cylinder.

Experiments were conducted to produce a consumable sheet incorporating capillaries. Two phases of extrusion work were undertaken. The first phase concerned the extrusion of chocolate using a capillary die attached to a small-scale extruder in a non-food grade environment for creating candy extrudates containing air filled capillaries in both low- and high-voidage forms.

The second phase of the experimental work built upon the first phase to produce low and high voidage extrudates containing an array of capillaries having cocoa butter filling. The first and second phases are described in the below Example.

It should be understood that the term “voidage” generally refers to the volume percent of the capillary volume relative to the sum of the capillary volume and the extruded body portion volume. That is voidage (%)=100×capillary volume/(capillary volume+extruded body portion volume). In some embodiments, the extruded body portion volume does not include any central region volume created by certain dies, such as an annular die.

Phase one concerned the extrusion of candy using a capillary die attached to a small-scale extruder, in order to confirm that chocolate sheets having capillaries in accordance with the present invention could be made.

The materials that were trialled during this investigation are shown in Table 1.

TABLE 1
Materials tested.

| Material | | |
|---|---|---|
| number | Material name | Application |
| 1 | Chocolate | Extruded matrix |
| 2 | Cocoa butter | Capillary |

Materials 1 was supplied as a large solid block, and was crushed prior to extrusion to yield a fine granular powder, with grain sizes ranging between 1 mm and 5 mm. Material 2 was supplied as a tub of solidified cocoa butter; the required quantity was broken up into a fine powder containing only small lumps before being fed into the heated cocoa butter reservoir.

The extrusion equipment consisted of a Betol single screw extruder, with a screw diameter of approximately 12 mm, and a screw L/D ratio of roughly 22.5:1. The extruder had four different temperature zones (denoted T1-T4 in FIG. 1 as described later), each of which could be independently controlled using PID controllers connected to band heaters. The Mk 3 MCF extrusion die, containing an entrainment array consisting of 17 hypodermic needles, was connected on the extruder endplate. Two opposed air jets, used to rapidly quench the extrudate emerging from the extrusion die, were placed above and below the die exit; these jets were connected via a valve to a compressed air line at 6 Barg. A schematic diagram showing the general layout of the extrusion line is shown in FIG. 1 and a schematic drawing of the capillary die is shown in FIG. 2.

With reference to FIG. 1, there is shown a schematic diagram of the extrusion apparatus 10 used in the experiments. The apparatus briefly comprises an electric motor 12 which is rotatably coupled to an extrusion screw 14. The screw 14 is fed at one end by a hopper 16 and the opposing end is coupled to an extrusion die 18 having an extrudate outlet 20. Quench jets 22 are directed towards the die outlet 20 so as to cool the extruded material 23 which is produced and these jets are fed with compressed air 24. If desired, the area of the apparatus where the hopper 16 is coupled to the screw 14 can be cooled by means of a cooling feed 26. Surrounding the screw 14 is a barrel 28 which is formed having three barrel temperature zones denoted T1 to T3—the temperatures of each zone being capable of being controlled. The barrel 28 is connected to the die 18 by means of a feed conduit 29 which also has a temperature zone T4 which can be controlled.

In use, the hopper 16 is filled with material 30 (such as chocolate) which can be heated so as to render it (or maintain it as) a liquid (not solid or solid particulate form). Alternatively it can be extruded in solid form as is known in the art. Before the material passes into the screw 14, it can be cooled by means of the cool feed 26, so as to ensure that the material is at the correct temperature for entering the screw extruder. As the screw is rotated, the liquid material is drawn along the screw 14, inside the barrel 28 and the temperature of the zones T1-T3 adjusted accordingly. The material then passes through the feed conduit 29 and the temperature is adjusted again (if required) by temperature control T4 before entering the die 18. The die 18 has a number of hollow needles (not shown) located within an entrainment body so that the chocolate material passes over and around the needles. At the same time that the chocolate is being extruded, compressed air 24 is forced through the centre of the central hollow needles so that the chocolate contains hollow capillaries. The air can be pulsed on and off to make capillaries which actually comprise a line of discrete bubbles, or the air pressure can simply be altered to give rise to continuous capillaries having a varying cross-sectional area along their length, from having a relatively wide diameter (for example, almost as wide as the body portion of the product itself) to extremely narrow (for example, on the micrometer scale). Similar effects can be achieved by rotating the die(s) and/or the extrudate to ‘nip’ the capillaries and thus produce ‘bubbles’, and by adjusting the rate of flow of the extrudate. The extrudate 23 is cooled by means of the quench jets 22 as it is released from the die 18. A valve 32 controls the flow of compressed air to the apparatus and pressure devices P1 and P2 control the pressure of the compressed air 24 before and after the valve. The compressed air line also has a temperature control T6 so as to control the temperature of the air before entering the die.

With reference to FIG. 2, there is shown an adaptation of the apparatus shown in FIG. 1. Rather than compressed air 24 being forced through central compressed needles, these needles are connected to a reservoir 50 containing cocoa butter. The reservoir 50 is heated so that the cocoa butter is maintained at the correct temperature so as to maintain it in a liquid state. The reservoir 50 is connected to a conduit 52 having an isolation valve 54 for controlling the flow of liquid. The conduit 52 is encased in a trace heating tube 56 which maintains the temperature of the conduit so that the liquid remains in a liquid state during its movement within the conduit. The conduit 52 is coupled to the inlet to the die 18 having number of needles, so that when the material is being extruded, the capillaries formed around and the needles can be simultaneously filled with cocoa butter. Of course, the capillaries could be filled with other types of liquid material if desired. The rate of flow of cocoa butter is adjusted with time to give rise to varying cross-sectional areas of the capillaries with length. If a line of discrete bubbles is required, the flow of cocoa butter is pulsated on and off. Again similar effects can be achieved by rotating the die(s) and/or the extrudate to ‘nip’ the capillaries and produce bubbles, and by adjusting the rate of flow of the extrudate.

FIG. 3 shows a die 18 in more detail. In particular, this figure shows that the metallic die 18 has, at one end, a plurality of needles 60 which are joined to a cavity 62 which is in fluid communication with an inlet channel 64 for pumping a fluid material into the channels of the extrudate.

With reference to FIG. 4, there is shown the die 18 in place in an entrainment body 70. Molten material 72 enters an opening 74 of the entrainment body 70 and the material is forced over and around the needles 60 of the die 18. At the same time, either air or liquid cocoa butter enters the die inlet by means of a fluid feed conduit 56. When operational, the molten material is extruded through the entrainment body 70 over the needles 60 of the die 18. Either air or cocoa butter is then pumped through the needles at the same time so as to produce an extrudate 23 (in direction 78) which either has channels with no filling or channels filled with cocoa butter. These channels can have varying cross-sectional area along their length (not shown), which is achieved by adjusting flow rates and/or use of rotation as discussed above.

The extrudate 23 is then processed further by either rolling or convoluting the extruded sheet. Depending upon the desired confectionery product, the extrudate (or part thereof) may be passed onto a rotating roller at a particular angle so as to effect a rolling action which will coil the extruded sheet. Alternatively, the extrudate (or part thereof) may be dropped onto a belt at a controlled velocity so as to effect a folding or convoluting action on the sheet. It will be apparent to the skilled addressee that the extruded sheet may be fed directly onto the roller or belt and then cut when the desired amount has been processed—or the extruded sheet may be cut prior to being fed on to the roller or belt.

FIG. 5a shows a side view of an extrusion die used to form a sheet according to the present invention. As is seen in the Figure, the die had has an orifice 51 that is generally rectangular in cross-section having a number of ridges protuberances along the upper and lower edges, and the orifice is used to extrude the substance from which the sheet is formed, for example chocolate. The orifice 51, whilst being generally rectangular, also comprises enlarged semi-circular portions 53. These enlarged semi-circular portions 53 extend around nozzles 52 located within the orifice 51, which are used to dispense a caramel filling. The sheet produced from the die of FIG. 5a is shown in FIG. 5b, and comprises a substantially planar sheet 55 of chocolate and having capillaries 54 running through the centre of the sheet and the exterior of the sheet corresponding to the shape of the orifice 51 of the die, the sheet having a number of parallel ridges 56 which extend over the length of the capillaries 54.

The sheet of FIG. 5b can be rolled or folded upon itself to form a confectionery product wherein the capillaries lie upon themselves, and consequently the capillaries lie perpendicular to the longitudinal axis of the rolled/folded sheet. A rolled sheet having capillaries that lie perpendicular to the longitudinal axis A-A of a rolled sheet is shown in FIGS. 6a and 6b. As shown in FIG. 6a, the rolling of the capillaries upon themselves gives rise to a bulge 62 at regular points along the longitudinal axis A-A of the rolled sheet 61. As shown in FIG. 6b, the rolled sheet 61 has a spiral cross-section at each end, and at the point of bulges 62, the rolled sheet has a larger cross-section than the end cross-section.

A folded sheet having capillaries that lie perpendicular to the longitudinal axis A-A of a folded sheet is shown in FIGS. 7a and 7b. As shown in FIG. 7a, the folding of the capillaries upon themselves again gives rise to a bulge 72 at regular points along the longitudinal axis A-A of the folded sheet 71. As shown in FIG. 7b, the folded sheet 71 has a random folded cross section at each end, and at the point of bulges 72, the folded sheet has a larger cross section than the end cross section.

Alternatively the sheet of FIG. 5b can be rolled or folded upon itself to form a confectionery product such that the capillaries lie parallel to one another, and consequently the capillaries lie parallel to the longitudinal axis A-A of the rolled/folded sheet. A rolled sheet having capillaries that lie parallel to the longitudinal axis A-A of a rolled sheet is shown in FIG. 8. As shown in this Figure, the rolling of the capillaries gives rise to bulges 82 than run parallel to the longitudinal axis A-A of the rolled sheet 81. The rolled sheet 81 has a spiral cross section that is the same along its entire length.

A folded sheet having capillaries that lie parallel to the longitudinal axis A-A of a rolled sheet is shown in FIG. 9. As shown in this Figure, the folding of the capillaries gives rise to bulges 92 that run parallel to the longitudinal axis A-A of the rolled sheet 91. The rolled sheet 91 has a random cross-section which may be the same along its entire length.

A different extrusion die, used to form a different sheet according to the present invention, is shown in side view in FIG. 10a. As is seen in the Figure, the die has an orifice 101 that is rectangular in cross-section and is used to extrude the substance from which the sheet is formed, for example chocolate. The orifice 101 houses nozzles 102, which are used to form the capillary and dispense the caramel filling. The sheet produced from the die of FIG. 10a is shown in FIG. 10b, and comprises a chocolate sheet 103 and capillaries of cocoa butter 104 running therethrough.

The sheet of FIG. 10b can be rolled or folded upon itself to form a confectionery product wherein the capillaries lie upon themselves, and consequently the capillaries lie perpendicular to the longitudinal axis A-A of the rolled/folded sheet. A rolled sheet having capillaries that lie perpendicular to the longitudinal axis A-A of a rolled sheet is shown in FIG. 11. As shown in this Figure, the rolling of the capillaries upon themselves does not gives rise to a bulge since the capillaries 104 do not alter the cross section of the sheet 103. As shown in FIG. 11, the rolled sheet has a spiral cross section at each end, and the diameter of the rolled sheet is the same along its length.

A folded sheet having capillaries that lie perpendicular to the longitudinal axis A-A of a folded sheet is shown in FIG. 12. As shown in this Figure, the folding of the capillaries upon themselves again does not give rise to a bulge. The folded sheet has a random folded cross section at each end, and the diameter of the folded sheet is the same along its length.

Alternatively the sheet of FIG. 10b can be rolled or folded upon itself to form a confectionery product such that the capillaries lie parallel to one another, and consequently the capillaries lie parallel to the longitudinal axis A-A of the rolled/folded sheet. A rolled sheet having capillaries that lie parallel to the longitudinal axis A-A of a rolled sheet is shown in FIG. 13. As shown in this Figure, the rolling of the capillaries again does not give rise to bulges 82 and the rolled sheet 81 has a spiral cross section that is the same along its entire length.

A folded sheet having capillaries that lie parallel to the longitudinal axis A-A of a rolled sheet is shown in FIG. 14. As shown in this Figure, the folding of the capillaries again does not give rise to bulges and the rolled sheet has a random cross section that is the same along its entire length.

Referring now to FIG. 15, a cylindrically shaped product 110 is shown which is formed from the sheet of FIG. 10b. however, rather than rolling the sheet 103 into a coil as shown in FIG. 13, the sheet is rolled so as to form a generally cylindrically shaped product with a large cavity 112 in the centre. Two distal edges of the sheet 114 and 116 overlap one another to a small degree; however, the edges 114, 116 can abut one another if desired. As shown in FIG. 15, the capillaries 104 lie parallel to the longitudinal axis A-A of the cylinder.

With reference to FIG. 16, a cylindrically shaped product 120 is shown which is similar to that shown in FIG. 15. However, rather than the capillaries running parallel to the longitudinal axis A-A of cylinder, the capillaries 122 run at an incline with respect to the longitudinal axis A-A of the cylinder.

Although the body portion and capillaries may be depicted as uniform in shape and pattern in some embodiments described herein, it should be understood that the body portion and/or the capillaries may be non-uniform in some embodiments. There may be variations in the overall dimensions of the product, such as, for instance, the dimensions of the body portion, the capillaries, the wall thicknesses between each capillary and the outer wall thickness of the product. For example, in some embodiments, the mechanical process of extrusion and optional further manipulation of the extrudate, such as stretching, may create non-uniformities in the dimensions of the product. Such processes also may create random variations in the positioning of the capillaries. The capillaries accordingly may be irregularly positioned in some embodiments. In addition, the capillaries may be symmetrically disposed in the body portion or asymmetrically disposed in the body portion. In some embodiments, one group of capillaries may be symmetrically disposed and another group of capillaries may be asymmetrically disposed in the body portion.

The invention is not restricted to the details of the foregoing embodiments, and many other embodiments will be apparent to the skilled addressee.

The above described confectionery products provide substantial interest to consumers and therefore give rise to increased consumer appeal. These products can be coated with any suitable product, such as a confectionery product, and the rolling/folding is readily achieved using processes well known in the art (such as the process for producing the Cadbury® Flake® and Cadbury® Spira®).

1. A confectionery composition comprising an at least partially convoluted or rolled sheet of a confectionery material having at least one capillary disposed therein, wherein the composition has a longitudinal axis which extends along the convolutions or axis of rolling and the at least one capillary runs parallel, perpendicular or at an inclined angle relative to the longitudinal axis of the product.

2. The composition of claim 1, wherein the sheet is no more than 5 mm in thickness.

3. The composition of claim 2, wherein the sheet is no more than 2.5 mm in thickness.

4. The composition of any preceding claim, wherein the confectionery material comprises chocolate.

5. The composition of any preceding claim, wherein the capillary is filled with a fluid material.

6. The composition of claim 5, wherein the fluid material is a liquid or a material which is liquid during the formation of the sheet.

7. The composition of claim 6, wherein the fluid material comprises one or more of caramel, cocoa butter, chocolate, fondant, syrup, peanut butter, jam, jelly, gel, truffle, praline or combinations thereof.

8. The composition of any preceding claim, wherein the confectionery material is extruded.

9. The composition of claim 8, wherein the confectionery material is extruded as a liquid.

10. The composition of any preceding claim, wherein the sheet is rolled into a coil or a cylinder.

11. The composition of any one of claims 1 to 9, wherein the sheet is convoluted so that the sheet is folded upon itself multiple times.

12. The composition of any one of claim 1 to 9 or 11, wherein the convolutions are random.

13. The composition of any preceding claim, wherein the sheet comprises a plurality of capillaries disposed therein.

14. A process for manufacturing a confectionery product comprising an at least partially convoluted or rolled sheet of a confectionery material having at least one capillary disposed therein, wherein the composition has a longitudinal axis which extends along the convolutions or axis of rolling and the at least one capillary runs parallel, perpendicular or at an inclined angle relative to the longitudinal axis of the product, wherein the process comprises the steps of:
(i) extruding an confectionery material to create a sheet comprising at least one capillary;
(ii) rolling or folding the sheet upon itself; and
(iii) optionally filling the capillary during or after extrusion.

15. The process of claim 14, wherein the sheet is formed with a plurality of capillaries.

16. The process of claim 14 or 15, wherein the process is used to make a confectionery product of any one of claims 1 to 13.

17. The process of any one of claims 14 to 16, wherein the process further comprises cutting and/or shaping the confectionery product.

18. The process of any one of claims 14 to 17, wherein the process further comprises covering the confectionery product in a coating.

19. The process of claim 18, wherein the coating comprises a chocolate coating.

20. An apparatus adapted for producing a confectionery product according to the process claimed in either of claims 14 to 19.

21. A confectionery product substantially as described herein and with reference to the accompanying drawings.

22. A process for producing an edible sheet substantially as described herein and with reference to the accompanying drawings.
